(19) United States
(12) Patent Application Publication
(10) Pub. No.: US 2010/0209256 A1
(43) Pub. Date: Aug. 19, 2010

(54) Element which Generates a Magnetic Field

(75) Inventors: Johannes Ante, Regensburg (DE); Stephan Heinrich, Pfeffenhausen (DE); Andreas Ott, Steinsberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/676,521

(22) PCT Filed: Sep. 1, 2008
(86) PCT No.: PCT/EP2008/061447

§ 371 Date: Mar. 4, 2010

(30) Foreign Application Priority Data
Sep. 4, 2007 (DE) 10 2007 041 901.7

(51) Int. Cl. F04D 29/00; B23P 17/00

(52) U.S. Cl. 416/244 R; 29/888

(57) ABSTRACT

An element which generates a magnetic field for securing a compressor wheel to a turboshaft of an exhaust-gas turbocharger, includes a base body that receives an annular-shaped magnet that rotates with the turboshaft. In order to provide an element which generates a magnetic field for securing a compressor wheel to a turboshaft of an exhaust-gas turbocharger, where the magnet is securely fixed and no change in the distribution of mass in the magnetic field occurs even when the magnet breaks, the magnet is connected in a force-fitting manner to the base body.

### PRIORITY CLAIM

This is a U.S. national stage of application No. PCT/EP2008/061447, filed on Sep. 1, 2008, which claims priority to the German Application No.: 10 2007 041 901.7, filed: Sep. 4, 2007; the contents of both which are incorporated here by reference.

### BACKGROUND OF THE INVENTION

1. Field of the Invention

The invention relates to an element for attachment of a compressor wheel to a turboshaft of an exhaust-gas turbocharger that produces a magnetic field, having a base body that holds a magnet, which rotates with the turboshaft.

2. Prior Art

The power produced by an internal combustion engine depends on the mass of air and the amount of fuel supplied to the internal combustion engine. To increase the power, it is generally necessary to supply more combustion air and fuel to the internal combustion engine. In the case of a naturally-aspirated engine, this power increase is achieved by enlarging the swept volume or by increasing the rotation speed. However, fundamentally increasing the swept volume leads to heavier internal combustion engines, with larger dimensions, which are therefore more expensive. Particularly in the case of large internal combustion engines, increasing the rotation speed leads to considerable problems and disadvantages.

One widely used technical solution for increasing the power of an internal combustion engine is boosting. This refers to compression of the combustion air in advance by an exhaust-gas turbocharger or else by means of a compressor which is mechanically driven by the engine. An exhaust-gas turbocharger essentially comprises a compressor and a turbine which are connected to a common shaft and rotate at the same rotation speed. The turbine converts the energy in the exhaust gas, which is normally blown out without being used, to rotation energy, and drives the compressor. The compressor sucks in fresh air and feeds the air which is being compressed in advance to the individual cylinders of the engine. The greater amount of air in the cylinders can have an increased amount of fuel added to it, as a result of which the internal combustion engine emits more power. The combustion process is furthermore advantageously influenced, as a result of which the internal combustion engine achieves a better overall efficiency. Furthermore, the torque profile of an internal combustion engine that is boosted by a turbocharger can be configured to be extremely advantageous.

As the amount of exhaust gas increases, the maximum permissible rotation speed of the combination comprising the turbine wheel, the compressor wheel and the turboshaft, which is also referred to as the exhaust-gas turbocharger train, can be exceeded. If the rotation speed of the train were to be impermissibly exceeded, it would be destroyed, leading to total damage to the turbocharger. In particular, small modem turbochargers, with considerably smaller turbine and compressor wheel diameters, which have a better rotation acceleration response because the mass moment of inertia is considerably smaller are particularly affected by the problem of the maximum permissible rotation speed being exceeded. Depending on the design of the turbocharger, the turbocharger may be completely destroyed just by the rotation speed limit being exceeded by about 5%.

The German patent application No. 10 2004 052 695.8 discloses an exhaust-gas turbocharger having a sensor at the compressor end of the turboshaft to measure the rotation speed of the turboshaft directly. In this case, the sensor is passed through the compressor housing and is directed at an element for variation of a magnetic field. The element for variation of the magnetic field is in the form of a permanent magnet which is arranged in an attachment element. The attachment element has a socket in which the magnet is mounted, with the magnet resting directly on the compressor wheel. If the attachment element is pressed against the compressor wheel with the desired tightening torque, then this results in forces which must be absorbed by the permanent magnet. This can damage the brittle material of the magnet. Furthermore, gases in the air inlet to the compressor can chemically attack and damage the permanent magnet.

### SUMMARY OF THE INVENTION

An element which produces a magnetic field, for attachment of a compressor wheel to a turboshaft of an exhaust-gas turbocharger, is therefore subject to particularly stringent technical requirements. It should have a uniform mass distribution which is as perfect as possible with respect to the turboshaft, and which does not change, even during operation of the element which produces a magnetic field. It should also be able to withstand a high mechanical tightening torque and produce a high magnetic field strength. It should also be resistant to the gases and the high temperatures in the air inlet of the compressor. One object of the present invention is to provide an element that produces a magnetic field, the element being for attachment of a compressor wheel to a turboshaft of an exhaust-gas turbocharger. The element satisfies the abovementioned requirements and the magnet is fixed securely. There is substantially no change in the mass distribution in the element that produces the magnetic field, even if the magnet fractures. A further object of the present invention is to specify a method by which an element which produces a magnetic field and has the stated characteristics can be produced.

Since the magnet is connected to the base body with a force fit, the mass cannot move at all in the base body even if the brittle material of the magnet fractures. A force which acts on the magnet and originates from the base body holds the magnet material in its position in all situations. Fracture of the magnet therefore does not cause the turboshaft to be unbalanced.

In one refinement, a thread is formed in the base body for screwing the element which produces a magnetic field to a thread on the turboshaft. The base body composed of high-strength material can accommodate a particularly fine thread, thus making it possible to screw the compressor wheel against the turboshaft with a high force. In this case, it is advantageous for the base body to be composed of non-magnetic, high-strength and weldable steel. This steel carries the magnetic field very well and can be welded well. The strength of this steel is extremely high.

In one embodiment of the invention, the magnet contains rare-earth metals. By way of example, rare-earth magnets such as NdFeB or SmCo magnets produce a relatively high magnetic field which can still be detected well, even by a sensor which is a relatively long distance away.

In embodiment of the invention, the base body has a higher coefficient of thermal expansion than the magnet. It is thus possible to insert the magnet into the heated base body and to produce the force fit between the base body and the magnet as the base body cools down. Even if the element which produces a magnetic field is heated to about 170° C. during operation in the air inlet of the turbocharger, the force fit is maintained between the base body and the magnet if the base body has been heated to about 330° C. for insertion of the magnet. In this case, the force fit between the base body and the magnet is created in the shrinking process after a heat treatment, which results in enormously high forces between the base body and the magnet, with the force fit being produced particularly intensively.

In one embodiment of the invention, the magnet is annular. An annular magnet allows a uniform mass distribution with respect to the rotation axis of the turboshaft to be achieved particularly easily.

In an embodiment of the invention, the element that produces a magnetic field additionally has a threaded body, wherein the threaded body is connected to the base body such that a tightening torque, which is transmitted to the base body, is also transmitted to the threaded body, and the magnet which is positioned between the base body and the threaded body is thus pressed by the threaded body against the base body, producing the force-fitting connection, or reinforcing a force-fitting connection which already exists between the base body and the magnet. This results in forces being applied to the magnet from all sides, as a result of which it cannot change its position in the socket even if the magnet material fractures. This prevents masses in the element which produces a magnetic field from moving, in all circumstances.

In this case, it is advantageous for the threaded body to be composed of 17-4PH steel also referred to as 1.4542 or 1.4548 steel. The strength of this steel is extremely high, and it can be welded. In this case, its soft-magnetic characteristics have no disruptive effect since the magnetic field can propagate well to the outside via the base body.

If the threaded body is connected to the base body by a weld, a torque acting on the base body can easily be passed to the threaded body. In combination with the weld, or as an alternative to this, the threaded body can be connected to the base body in an interlocking manner and/or by a crimp.

In one embodiment of the invention, the magnet is connected to the base body with a force fit, in that a sleeve body, which is connected to the base body using the magnetic pulse method, presses the magnet into the socket in the base body. When using the magnetic pulse method, the sleeve body produces an excellent force-fitting connection between the magnet and the base body. Elements which produce a magnetic field and have been manufactured using this method can be produced very cost-effectively and with high quality.

With respect to the method, a magnet is first of all inserted into a socket in a base body, and a sleeve body is then pushed over the base body with the magnet, after which the sleeve body is connected to the base body by a magnetic pulse, with a force being created which pushes the magnet into the socket, with a force-fitting connection being produced between the base body and the magnet.

### BRIEF DESCRIPTION OF THE DRAWINGS

Embodiments of the invention are illustrated by way of example in the figures, in which:

FIG. 1: is an exhaust-gas turbocharger having a turbine and a compressor;

FIG. 2: is a cross section illustration of the compressor;

FIG. 3: is an element which produces a magnetic field;

FIG. 4: is an element which produces a magnetic field and is formed from three parts;

FIG. 5: is an element which produces a magnetic field;

FIG. 6: is a three-part embodiment of the element which produces a magnetic field;

FIG. 7: is a three-part embodiment of the element which produces a magnetic field;

FIG. 8: is an element which produces a magnetic field, having a base body which is at the same time in the form of a threaded body;

FIG. 9: shows the situation after the influence of the magnetic pulse; and

FIG. 10: shows an arrangement for connection of the sleeve body to the base body using the magnetic pulse method.

### DETAILED DESCRIPTION OF THE DRAWINGS

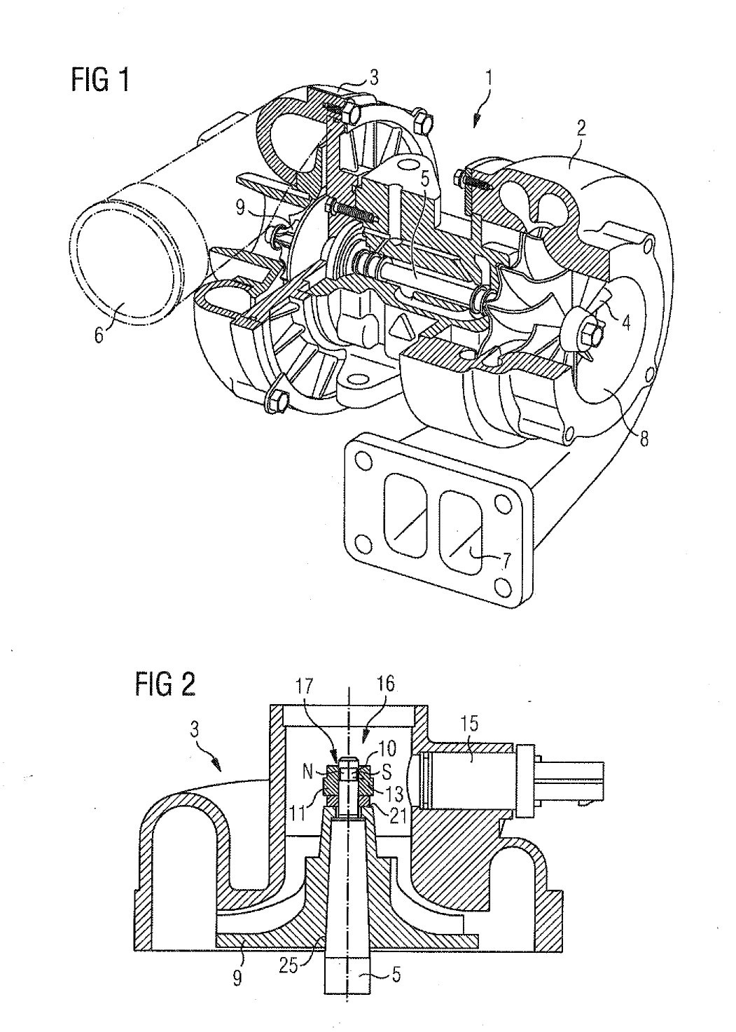

FIG. 1 is an exhaust-gas turbocharger 1 having a turbine 2 and a compressor 3. The compressor wheel 9 is mounted in the compressor 3, and is connected to the turboshaft 5, such that it can rotate. The turboshaft 5 is also mounted such that it can rotate, and is connected at its other end to the turbine wheel 4. The combination comprising the compressor wheel 9, the turboshaft 5 and the turbine wheel 4 is also referred to as the train. Hot exhaust gas from an internal combustion engine, which is not illustrated here, is introduced into the turbine 2 via the turbine inlet 7, causing the turbine wheel 4 to rotate. The exhaust-gas flow leaves the turbine 2 through the turbine outlet 8. The turbine wheel 4 is connected to the compressor wheel 9 via the turboshaft 5. The turbine 2 therefore drives the compressor 3. Air is drawn into the compressor 3 through the air inlet 16, is then compressed in the compressor 3, and is supplied via the air outlet 6 to the internal combustion engine.

FIG. 2 shows a cross section illustration of the compressor 3. The compressor wheel 9 can be seen in the compressor housing. The compressor wheel 9 is mounted on the turboshaft 5 with the element 17 which produces a magnetic field. The element 17 which produces a magnetic field is located in the air inlet 16 of the compressor 3. The element 17 which produces a magnetic field may be in the form of a cap nut which is screwed onto a thread which has been applied to the turboshaft 5, in order to brace the compressor wheel 9 firmly against a collar on the turboshaft 5. An annular permanent magnet 13 is located in the element 17 which produces a magnetic field, in order to attach the compressor wheel 9 to the turboshaft 5. When the turboshaft 5 is rotating, the magnet 13 rotates with it about the rotation axis of the turboshaft 5. During the process, the magnet 13 produces a change in the magnetic field strength or the magnetic field gradient in the sensor 15. This change in the magnetic field or the field gradient produces a signal in the sensor 15, which signal can be processed electronically and is proportional to the rotation speed of the turboshaft 5.

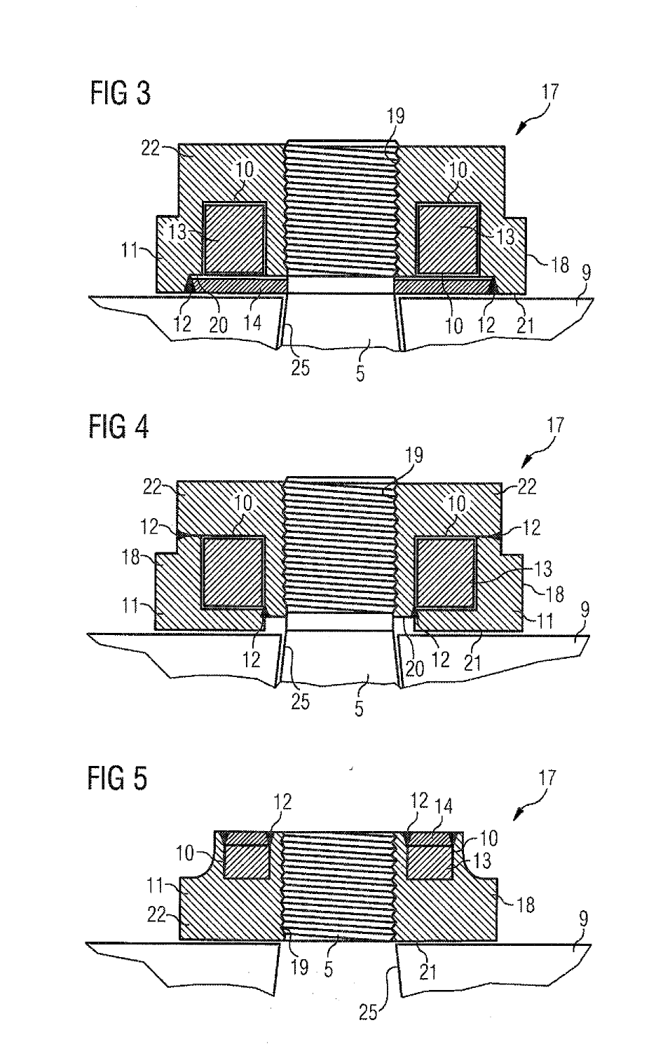

FIG. 3 shows a side cross section illustration of an element 17 which produces a magnetic field, for attachment of a compressor wheel 9 to a turboshaft 5. The base body 11 has a socket 10 into which the permanent magnet 13 is fitted. A thermal process can be used for fitting the magnet 13. Both the base body 11 on its own and the base body 11 together with the magnet 13 are heated to a temperature above the normal operating temperature of the element 17 which produces a magnetic field in the turbocharger.

During this process, care should be taken to ensure that the permanent magnet 13 is as far as possible not heated above its Curie temperature. A Ferromagnet loses its spontaneous magnetization if it is heated above its Curie temperature. The Ferromagnet recovers its ferromagnetic characteristics somewhat below this temperature, that is to say it exhibits spontaneous magnetization even without any applied external field. Above the Curie temperature, the material then exhibits only a paramagnetic behavior, that is to say the material is magnetized by an external field but loses its magnetization again when the magnetic field is switched off. When the Curie temperature T_{c} is undershot, the magnet passes through a phase transition from the paramagnetic phase to the ferromagnetic phase. Despite the spontaneous resumption of the magnetic characteristics when the Curie temperature is undershot, there is actually no point in destroying the magnetic characteristics of annular magnets 13 because a magnet with characteristics that are not the same as the original characteristics may subsequently be formed. The Curie temperature of some typical magnetic materials is for: Cobalt 1394K (1121° C.), iron 1041 K (768° C.) and nickel 633 K (360° C.).

In order to fit the magnet 13, the base body 11 has a considerably higher coefficient of thermal expansion (CTE) than the permanent magnet 13. The base body 11 should have a coefficient of thermal expansion (CTE) of about 15 to 20 ppm/K while the magnet 13 should have a coefficient of thermal expansion (CTE) from about 5 to 10 ppm/K. This ensures that an element 17 which produces a magnetic field and is heated to a temperature of 330° C., which is below the Curie temperature of nickel, decreases its volume sufficiently when cooling down to build a stress between the base body 11 and the magnet 13 which leads to an adequate force-fitting connection between the base body 11 and the magnet 13. The process of reducing the volume of a material when it is cooling down is also referred to as shrinking. For the shrinking process, the magnet 13 is inserted into the socket 10 in the heated base body 13, and the element 17 which produces a magnetic field that has been assembled in this way is then cooled down. Even if the element 17 which produces a magnetic field is heated to about 170° C. during operation in the air inlet 16 of the turbocharger 1, the force-fitting connection between the base body 11 and the magnet 13 will continue to exist in an adequate manner since the operating temperature of 170° C. is well below the production temperature of 330° C. which was chosen as the initial temperature for the shrinking process.

To protect the magnet 13 against mechanical loads and chemically reactive gases, the socket 10 is closed with a protective cap 14. The socket 10 can be closed with the protective cap 14 by the application of weld beads 12 which, on the one hand, ensure high mechanical robustness and, on the other hand, result in a gas-tight seal between the socket and the external environment. In this example, the protective cap 14 is supported on a circumferential step 20 as a result of which the protective cap 14 and the upper area of the base body 11 form a flat surface. Furthermore, the base body 11 of the element 17 which produces a magnetic field has a thread 19, by which the element 17 which produces a magnetic field can be screwed onto an external thread on a turboshaft 5. By way of example, a hexagon 18 may be formed on the element 17 which produces a magnetic field, for a wrench to be fitted to. When the element 17, which produces a magnetic field, has been screwed onto the turboshaft 5, it presses the compressor wheel 9 firmly against a conical seat 25 on the turboshaft 5. Enormously high tightening torques are transmitted to the element 17 which produces a magnetic field, in order to achieve a secure and long-life connection between the compressor wheel 9 and the turboshaft 5. The material of the base body 11 and that of the threaded body 22 which will be introduced later are therefore subject to very stringent strength requirements. The material of the permanent magnet is brittle and fragile. In order not to change the center of gravity of the element 17 which produces a magnetic field and rotates at high speed, even if the permanent magnet 13 fractures, the mass of the element 17 which produces a magnetic field must not move at all in the base body 11. At this point, it should be noted that the train of a turbocharger can rotate at more than 270 000 revolutions per minute. Even a very minor non-uniform mass distribution with respect to the rotation axis of the train would also lead to enormous forces, which can attack the bearings of the turboshaft and can destroy them. The element 17 which produces a magnetic field is an extremely highly loaded component, since the element 17 which produces a magnetic field is subject to chemically highly reactive gases because of the exhaust gas being fed back into the air inlet 16 of the exhaust-gas turbocharger 1. All of these influences result in a requirement for particularly careful design of the element 17 which produces a magnetic field, well beyond the development of conventional attachment elements.

FIG. 4 is a further refinement of the element 17 which produces a magnetic field. In this case, the element 17 which produces a magnetic field is in three parts, having a base body 11, a threaded body 22 and the magnet 13. The magnet 13 is mounted in a socket 10 between the base body 11 and the threaded body 22. The magnet 13 is connected to the threaded body 22 and the base body 11 with a force fit by means of an appropriate shrinking process. For this purpose, by way of example, the base body 11 can be heated to a temperature of 330° C., with the socket 10 expanding to such an extent that the magnet 13 can be fitted into it. Because of the different coefficients of thermal expansion CTE of the base body 11 and of the magnet 13, a force-fitting connection is created between the magnet 13 and the base body 11 when they cool down. The threaded body 22 is then cooled down using liquid nitrogen, after which the threaded body 22 is passed over the combination of the base body 11 and the magnet 13. The threaded body 22 is now heated, for example to room temperature, thus creating a force-fitting connection between the magnet 13 and the threaded body 22. Furthermore, for example, a welded joint 12 or an interlocking connection can be produced between the base body 11 and the threaded body 22. The base body 11 transmits a torque acting on it to the threaded body 22 through this connection. By way of example, the torque can be produced by a turning tool fitted to the hexagon 18. The torque that is applied results in the thread 19 in the threaded body 22 being screwed onto the thread on the turboshaft 5, as a result of which the compressor wheel 9 is pressed against a conical seat 25 on the turboshaft 5. As the threaded body 22 is screwed on, this transmits a force to the magnet 13, resulting in the magnet 13 being pushed in between the base body 11 and the threaded body 22, and being connected to them with a force fit. This results in the magnet 13 being fixed completely, both in the axial and radial directions, with respect to the rotation axis of the turboshaft 5. Even if the brittle magnet material fractures, the embodiment according to the invention of the element 17 which produces a magnetic field means that the magnetic material which is mounted in the socket 10 cannot move at all. The force-fitting connections between the magnet 13 and the base body 11 as well as the threaded body 22 ensure that the element 17 which produces a magnetic field maintains a uniform mass distribution with respect to the rotation axis of the turboshaft 5, in all circumstances. Any disturbance of this uniform mass distribution with respect to the rotation axis of the turboshaft 5 can lead to catastrophic damage to the turbocharger, as has already been stated, and this is effectively prevented by the element 17 which produces a magnetic field according to the invention.

FIG. 5 is a further embodiment of the force-fitting connection according to the invention between the magnet 13 and the base body 11. The base body 11 can also be seen here, and is at the same time used as the threaded body 22. A socket 10 is formed in the base body 11, and the magnet 13 is introduced into this socket 10 with a force fit, by the shrinking process. For this purpose, by way of example, the base body 11 is heated to 330° C. and the magnet 13, which in this case is in the form of a ring magnet is then inserted into the socket 10, after which the element 17 which produces a magnetic field is cooled down. A protective cap 14 is then fitted, and is welded to the base body 11. In this case, weld beads are identified by the reference symbol 12. A thread 19 is formed on the element 17 which produces a magnetic field, and allows the element 17 which produces a magnetic field to be screwed onto the turboshaft 5, pressing the compressor wheel 9 against a conical seat 25 on the turboshaft 5.

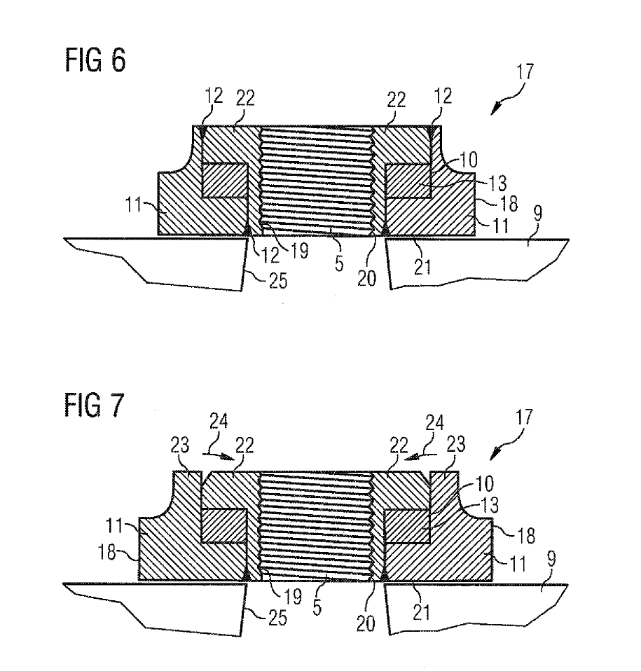

FIG. 6 is a three-part embodiment of the element that produces a magnetic field. This shows the base body 11 and the threaded body 22, which together form a socket 10. The magnet 13 is inserted into the socket 10 with a force fit. This can be done as described in FIG. 4, for example by first of all heating the base body 11 to a temperature of 330° C., after which the magnet 13 is inserted into the socket 10, and the structure comprising the base body and the magnet is cooled down. By way of example, the threaded body 22 is cooled down in liquid nitrogen and is itself pulled with the socket onto the magnet 13. Once the element 17 which produces a magnetic field has been heated up to room temperature, a force-fitting connection is created between the base body 11 and the threaded body 22 as well as the magnet 13 located between them. Furthermore, the base body 11 and the threaded body 22 can be connected to one another by a weld bead 12 or an interlocking connection, which is not illustrated here. When the element 17 which produces a magnetic field and has been created in this way is screwed onto the thread on the turboshaft 5, a torque is transmitted from the base body 11 to the threaded body 22, which itself exerts pressure on the magnet 13, by which the latter has a force applied to it in the axial direction with respect to the rotation axis of the turboshaft 5, which force leads to a force-fitting connection between the magnet 13 and the threaded body 22 on the one hand, and the magnet 13 and the base body 11 on the other hand. This results in the magnet 13 being held firmly in the socket 10 from all sides, as a result of which no mass movement whatsoever can occur within the magnet 13.

FIG. 7 shows a further three-part embodiment of the element 17 which produces a magnetic field. The magnet 13 is once again connected with a force fit to the base body 11 and the threaded body 22, and this can be done analogously to the procedure described in FIG. 6. Furthermore, the base body 11 contains a crimp 23, which is placed on the threaded body 22 in the crimp direction 24. The crimp 23 can be applied, for example, using the magnetic pulse method, or else with the aid of mechanical tools. This results in a further force-fitting and interlocking connection between the base body 11 and the threaded body 22. When the element 17 which produces a magnetic field is tightened against the compressor wheel 9, this results in a force which is transmitted from the base body 22 to the magnet 13 and leads to a force-fitting connection between the threaded body 22 and the magnet 13 on the one hand, and the base body 11 and the magnet 13 on the other hand.

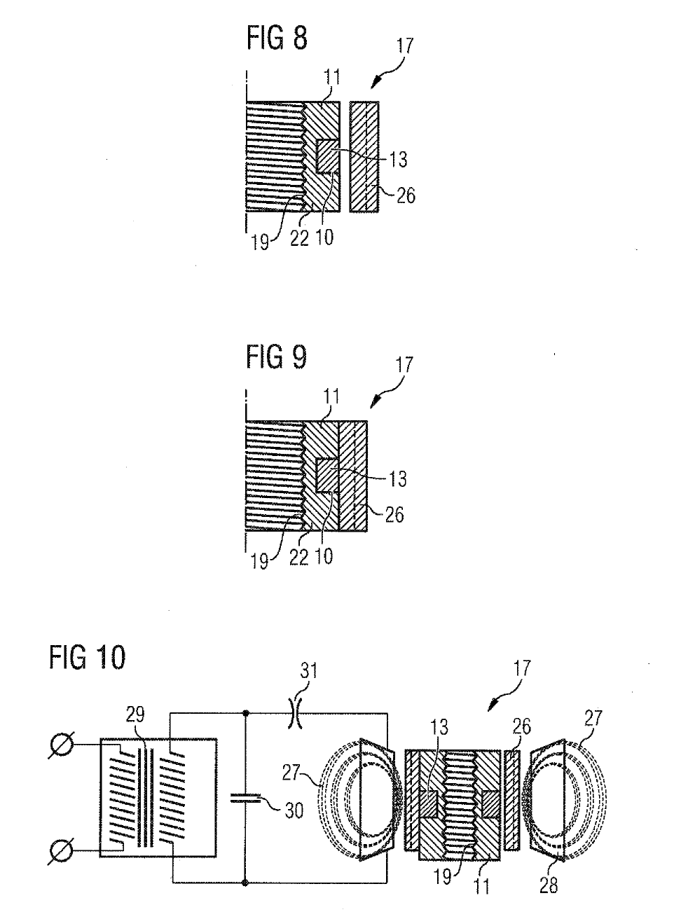

FIG. 8 shows an element 17 which produces a magnetic field having a base body 11 which is at the same time in the form of a threaded body 22. The thread 19, as well as the socket 10 can be seen in the threaded body 22. The magnet 13 (for example in the form of two magnetic half-shells) is arranged in the socket 10, and a sleeve body 26 is placed over the base body 11. In FIG. 8, the sleeve body 26 has not yet been connected to the base body 11. The sleeve body 26 is connected to the base body 11 using the so-called magnetic pulse method, as is illustrated in more detail in FIG. 10. In this case, a pulse with a high magnetic field strength acts on the sleeve body 26, with the sleeve body 26 being accelerated against the base body 11. This enormous acceleration of the sleeve body 26 against the base body 11 results in a cold weld being formed between the base body 11 and the sleeve body 26. Furthermore, the sleeve body 26 builds up a high force against the base body 11, and thus presses the magnet 13 into the socket 10. The magnet 13 is therefore connected to the base body 11 with a force fit, and can never change its position, even if the magnetic material fractures.

FIG. 9 illustrates the situation after the action of the magnetic pulse. Once again, the element 17 which produces a magnetic field can be seen with the base body 11. In this example, the base body 11 at the same time forms the threaded body 22 with the thread 19. The socket 10 in which the magnet 13 is mounted can be seen in the base body 11. The sleeve body 26 is now cold-welded to the base body 11, after the action of the magnetic pulse, and the magnet 13 is pressed firmly into the socket 10. The force-fitting connection resulting from this between the base body 11 and the magnet 13 guarantees that no change occurs to the mass substantially mounted in the socket 10.

FIG. 10 is an arrangement for the connection of the sleeve body 26 to the base body 11 using the magnetic pulse method. The figure shows a transformer 29, which is fed from an electrical power source and produces a high level of electrical energy in the capacitor 30. The heavy-current switch 31 is switched on when the capacitor 30 has been charged with sufficient electrical energy. An enormously high current then flows via the electrical lines to the magnet coils 28. A magnetic field with an enormously high magnetic field strength is built up in a very short time, and this is referred to as the magnetic pulse 27. This magnetic pulse 27 interacts with the sleeve body 26, and accelerates the material of the sleeve body 26 in the direction of the base body 11. The extremely high magnetic force produces sufficiently great acceleration of the material of the sleeve body 26 against the material of the base body 11 that the materials of the two bodies are cold-welded to one another. The high pressure which likewise results from the acceleration of the sleeve body 26 against the base body 11 produces a force-fitting connection between the magnet 13 and the base body 11. The high speed at which the material of the sleeve body 26 is accelerated by the magnetic pulse 27 against the material of the base body 11 results in the interatomic repulsion forces between the atoms of the two materials being overcome, and in the atoms which impact on one another being connected in such a way that they can jointly use electronic levels. The weld which is created in this way is considerably stronger than a weld which results from a conventional thermal process. Furthermore, materials which have considerably different welding temperatures can be connected in this way, for example aluminum and steel, as well as materials which cannot be thermally welded to one another. The process of magnetic pulse welding between the materials takes place in a very short time which is generally in the region of milliseconds.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. An element to attach a compressor wheel to a turboshaft of an exhaust-gas turbocharger configured to produce a magnetic field, comprising:
a magnet; and
a base body that rotates with the turboshaft and configured to hold the magnet, wherein the magnet is connected to the base body with a force fit.

17. The element to attach the compressor wheel to the turboshaft of the exhaust-gas turbocharger configured to produce the magnetic field, as claimed in claim 16, wherein a thread is formed in the base body configured to screw the element that produces a magnetic field to a thread on the turboshaft.

18. The element to attach the compressor wheel to the turboshaft of the exhaust-gas turbocharger configured to produce the magnetic field, as claimed in claim 16, wherein the base body comprises a non-magnetic, high-strength, and weldable steel.

19. The element to attach the compressor wheel to the turboshaft of the exhaust-gas turbocharger configured to produce the magnetic field, as claimed in claim 16, wherein the magnet comprises rare-earth metals.

20. The element to attach the compressor wheel to the turboshaft of the exhaust-gas turbocharger configured to produce the magnetic field, as claimed in claim 16, wherein the base body has a higher coefficient of thermal expansion than the magnet.

21. The element to attach the compressor wheel to the turboshaft of the exhaust-gas turbocharger configured to produce the magnetic field, as claimed in claim 20, wherein the force fit between the base body and the magnet is created based on a shrinking process after a heat treatment.

22. The element to attach the compressor wheel to the turboshaft of the exhaust-gas turbocharger configured to produce the magnetic field, as claimed in claim 16, wherein the magnet is annular.

23. The element to attach the compressor wheel to the turboshaft of the exhaust-gas turbocharger configured to produce the magnetic field, as claimed in claim 16, further comprising a threaded body connected to the base body, such that a tightening torque transmitted to the base body, is also transmitted to the threaded body, and the magnet which is positioned between the base body and the threaded body is thus pressed by the threaded body against the base body,
whereby the force-fitting connection between the base body and the magnet is one of produced and reinforced by the threaded body.

24. The element to attach the compressor wheel to the turboshaft of the exhaust-gas turbocharger configured to produce the magnetic field, as claimed in claim 23, wherein the threaded body is one of 17-4PH steel, 1.4542 steel, and 1.4548 steel.

25. The element to attach the compressor wheel to the turboshaft of the exhaust-gas turbocharger configured to produce the magnetic field, as claimed in claim 23, wherein the threaded body is connected to the base body by a weld.

26. The element to attach the compressor wheel to the turboshaft of the exhaust-gas turbocharger configured to produce the magnetic field, as claimed in claim 23, wherein the threaded body is connected to the base body in an interlocking manner.

27. The element to attach the compressor wheel to the turboshaft of the exhaust-gas turbocharger configured to produce the magnetic field, as claimed in claim 23, wherein the threaded body is connected to the base body by a crimp.

28. The element to attach the compressor wheel to the turboshaft of the exhaust-gas turbocharger configured to produce the magnetic field, as claimed in claim 27, wherein the crimp is applied to the threaded body using a magnetic pulse method.

29. An element that produces a magnetic field and attaches a compressor wheel to a turboshaft of an exhaust-gas turbocharger, comprising:
a base body which rotates with the turboshaft having an annular socket; and
at least one magnet arranged in the annular socket and connected to the base body with a force fit; and
a sleeve body connected to the base body using a magnetic pulse method,
wherein the sleeve body presses the magnet into the socket in the base body.

30. A method for producing of an element that produces a magnetic field and attaches a compressor wheel to a turboshaft of an exhaust-gas turbocharger, comprising:
inserting a magnet into a socket of a base body;
pushing a sleeve body is then pushed over the base body with the magnet; and
connecting the sleeve body to the base body by a magnetic pulse, with a force being created that pushes the magnet into the socket, whereby a force-fitting connection is produced between the base body and the magnet.

31. The element to attach the compressor wheel to the turboshaft of the exhaust-gas turbocharger configured to produce the magnetic field, as claimed in claim 16, wherein the base body is composed of a non-magnetic, high-strength, and weldable steel.

32. The element to attach the compressor wheel to the turboshaft of the exhaust-gas turbocharger configured to produce the magnetic field, as claimed in claim 21, wherein the magnet is annular.
